(19) United States
(12) Patent Application Publication
(10) Pub. No.: US 2008/0011498 A1
(43) Pub. Date: Jan. 17, 2008

(54) Cultivator and blade

(76) Inventor: Bruce Leon Catlin, West Valley City, UT (US)

Correspondence Address: MARCUS G THEODORE, PC, 466 SOUTH 500 EAST, SALT LAKE CITY, UT, 84102, US

(21) Appl. No.: 11/502,734

(22) Filed: Aug. 12, 2006

Related U.S. Application Data
(63) Continuation-in-part of application No. 11/485,056, filed on Jul. 12, 2006.

(51) Int. Cl. A01B 13/08

(52) U.S. Cl. 172/699

(57) ABSTRACT

An improved cultivator and blade attachment particularly suited for use with smaller ground plots and provides the advantages of an improved tiller blade design, which can be used laterally as well as horizontally to minimize blade migration.

### RELATED APPLICATIONS

This application is a continuation-in-part patent application of the patent application entitled “Power Drill Cultivator Attachment” filed Jul. 12, 2006 and assigned Ser. No. 11/485,056

### BACKGROUND OF THE INVENTION

1. Field

This invention pertains to cultivators. More particularly, it relates to a cultivator and cultivator attachment for manual or rotary powered drive.

2. State of the Art

A number of cultivators are known. Hound Dog® Products, Inc. of Eden Prairie, Minn. produces a number of hand powered hand tool cultivators, such as its three pronged Mini-Tiller, and its six pronged Garden Hound® Tiller. These manual tools require a user to rotate the tool prongs to till the soil and are of limited use for smaller plots. Faultless Starch/Bon Ami® Company of Kansas City, Mo. also produces a similar line of hand cultivators, such as its Garden Claw™.

Other powered cultivators such as Howard, U.S. Pat. No. 5,810,093 issued Sep. 22, 1998 disclose a multipurpose landscaping device for use as a hand-held rotary power tool. It has a shaft with one end adapted for attachment to a power drill, and the other end adapted for use with a greenery cutter, a blower, a pruner, a U-shaped soil auger and a weed extractor. Jerez, U.S. Pat. No. 5,491,963 issued Feb. 20, 1996 discloses a garden cleaning implement with rotating rectangular blade cutting members for cutting/macerating weeds above and below ground. Jerez, U.S. Pat. No. 6,247,539 issued Jun. 19, 2001 discloses a cultivator implement with castellated cultivating protrusions and multi-implement powered cultivation system using spool filament and bumper feed for cutting. Marshall et al, U.S. Pat. No. 6,189,627 issued Feb. 20, 2001 discloses a lawn and garden tool arranged to provide low speed and high torque to power various implements such as tillers and drills. Marshall's tiller blade arrangement has a tendency to wander when in use and consequently requires directional control assistance from a handle.

Other farm tiller implements employing riding vehicles are known, but are not suitable for use with smaller plots or gardens.

Cited for general interest is Spence, U.S. Pat. No. 4,289,214 issued Sep. 15, 1981 disclosing a multi-purpose vehicle, which can be used with tillers and other farm implements.

The invention described below provides an improved manual or power drill cultivator blade attachment or device for use with smaller plots and provides the advantages of an improved tiller blade design, which can be used laterally as well as horizontally to minimize migration.

### SUMMARY OF THE INVENTION

The invention comprises a cultivating blade attachment and device comprising a shaft with an attachment end adapted to attach to a manually rotated or low speed high torque rotary power source such as a variable speed drill. At the other end it has a cultivator end with at least three spaced apart blades attached to the cultivator end. Each blade is bent away from the shaft such that its tips are separated and adapted to drill into the soil as the cultivating blades are rotated such that the soil is tilled without blade migration. These blades are structured to entangle and pull weeds as they are rotated to till the soil.

In the simplest embodiment, at least three blades are attached to the cultivator end of the shaft, and the attachment end is adapted to fit within a drill chuck. For dandelion removal, four blades equally spaced apart and in parallel alignment are attached to the cultivator end of the shaft such that when they are rotated a tubular soil core containing roots is removed.

To prevent the cultivating blade from migrating during use, a vertical drill stabilizer may be included and positioned in the center of the spaced apart blades extending there beyond to drill into the soil and hold the position of the cultivating blades as the rotating blades cultivate and till the soil. This particular embodiment is used to “drill” a series of cultivating holes to churn and till the soil. A user can then remove the entangled weeds from the blades or till them into the soil for mulch.

A second pair of horizontal stabilizer blades may be interposed between the four equally spaced apart stabilizer blades with their tips spread apart wider than the blades such that they are not in planer alignment to act as additional horizontal stabilizers to minimize blade migration when in use.

In one preferred embodiment, the blades are attached to a shaft is of a fixed length to minimize user stooping. With these longer shafts, a tubular hand guide with an optional handle affixed thereto may be included surrounding the shaft to enable the center shaft to spin freely within the tubular hand guide. This tubular hand guide serves as a handle or grip to assist in controlling the alignment when the user is using a longer shaft tool in a standing position.

In another preferred embodiment, the length of the shaft is adjustable. This adjustable shaft reduces stooping when extended, but can then be collapsed to enable the user to remove weeds from the cultivator blades with minimal repositioning the cultivating tool. This embodiment eliminates the need to have different length shafts, if one wants to operate close to the ground, or hold the blades farther away for use in an upright position.

The preferred embodiment of the cultivating blade attachment has an attachment end adapted to attach to the chuck of a low speed high torque rotary drill with a handle to assist in aligning the blade attachment. When using the cultivating blade attachment in harder soils, preferably a handle is attached to the variable speed drill to assist in aligning the cultivating blade attachment. The cultivator end of this preferred embodiment has at least four spaced apart blades (preferably equally spaced apart to prevent wobble during use). A central drill stabilizer is attached to the cultivator end in the center of the blades to drill in the soil and prevent tool migration. Each blade extends and is bent away from alignment with the center shaft to slightly drag its tips into the soil as it rotates. These blades are angled such that they ensnare the weeds and enwrap them about the cultivator blades pulling them at the same time the blades loosen the soil. Enwrapped weeds are then periodically removed from the blades and discarded. This embodiment may also include a horizontal stabilizer, which allows the cultivating blade attachment to be used at an inclined angle without causing migration.

The span of the spaced apart blade tips varies and is chosen based on the compactness of the soil. Smaller diameter spaced apart blade tips are used in tighter more compact soils and it areas where it is desired to work closer to the base of plants without damage to them. Wider more spaced apart blade tips with additional blades are used in larger areas or in areas where the soil is less compact requiring less torque. Thus a variety of cultivating attachments may be included in a kit and employed to meet the cultivating needs of a user under various soil conditions and types.

These cultivating blade attachments are preferably made of cast or welded metals resistant to corrosion, and of a thickness to withstand the cultivating forces incurred when in use. Steels or other metals are therefore preferred, and provide a washable tool after use.

The above cultivating blade attachment thus provides the combined advantages of a power cultivator, as well as the efficiencies of an interchangeable attachment readily adaptable for various soil conditions.

The variable speed drill allows power to be applied continuously or sporadically to meet the desired cultivating force. Although a battery powered device is preferred, a drill with an electrical cord is also contemplated, so that the cultivating blade attachment may be used with any power drill.

In another preferred embodiment, the cultivating blades are part of a manually operated cultivator device, which comprises a rotating crank handle attached to a shaft having a manual hand crank end, and a cultivating end. The cultivating end has a plurality of spaced apart blades as described above. The shaft is then rotated by manually operation to rotate cultivating blades. This manual hand crank embodiment allows the user to employ varying torque as needed to till different types of soils.

Another manually operated embodiment has the shaft and handle modified as a push drill to rotate the shaft as the device is pushed into the ground. This manual embodiment requires adaptation of the push drill mechanism so that the tool may be used on a slant by including a second hand slide so that the blades rotate as both hands move the push slide spiral housing up and down to rotate the shaft.

In another preferred embodiment, the long shaft cultivator is power driven with a power drill as described above. The long shaft is encased in a tubular casing surrounding the shaft to enable the centered shaft to spin freely within the tubular hand guide. The tubular hand guide may be held in a manner to position the shaft in the desired location. This tubular hand guide serves as a handle or grip to assist in controlling the alignment when the user is using a longer shaft tool in a standing position. The hand guide may include a handle attached at right angles to assist in positioning the cultivating tool. Thus a user holds the power drill in one hand and grasps the handle in the other to operate the cultivator tool.

The invention thus provides an improved manual or power drill cultivator blade attachment and/or device for use with smaller plots and provides the advantages of an improved tiller blade design, which can be used laterally as well as horizontally to minimize migration. Lateral usage is particularly effective when one wants to disc the soil. Horizontal usage is better adapted for a drilling type of action.

### DESCRIPTION OF THE DRAWINGS

FIG. 1 is a perspective view of a three blade cultivating blade attachment.

FIG. 2 is a perspective view of the embodiment shown in FIG. 1 with a vertical stabilizer.

FIG. 3 is a perspective view of a four blade cultivating blade attachment with a vertical stabilizer.

FIG. 4 is a perspective view of a three blade cultivating blade attachment with a horizontal stabilizer.

FIG. 5 is a perspective view of a three blade cultivating blade attachment with both vertical and horizontal stabilizers.

FIG. 6 is a perspective view of a four blade cultivating blade attachment with both vertical and horizontal stabilizers.

FIG. 7 is a perspective view of a four blade cultivating blade attachment with bent blades and a vertical stabilizer.

FIG. 8 is a perspective view of the embodiment of claim 7 with a telescoping shaft attached to a power drill.

FIG. 9 is a front view of a four blade cultivating blade attachment.

FIG. 9a is an end view of the four blade cultivating blade attachment shown in FIG. 9.

FIG. 10 is a perspective view of a manually operated cultivator.

FIG. 11 is a perspective view of a preferred power operated cultivator.

FIG. 12 is a perspective view of another manually operated cultivator.

FIG. 13 is a perspective view of another manually operated cultivator.

### DESCRIPTION OF THE ILLUSTRATED EMBODIMENTS

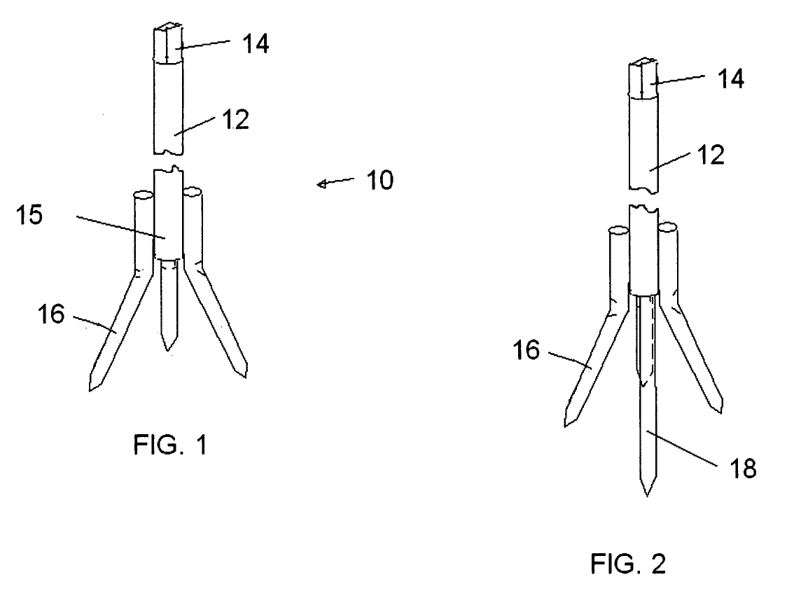

FIG. 1 is a perspective view of the simplest embodiment of the invention 10. It has a cylindrical shaft 12 with a round/square attachment end 14 adapted to fit within the chuck of a conventional power drill. The shaft 12 cultivating end 15 has three blades 16 attached and equally spread apart. The invention 10 is made of steel with the blades made of bent 60 penny gauge nails or tubular metal welded to the cultivating end 15 of the shaft 12 such that the blades 16 can be bent inwardly or outwardly, if desired to till different soils.

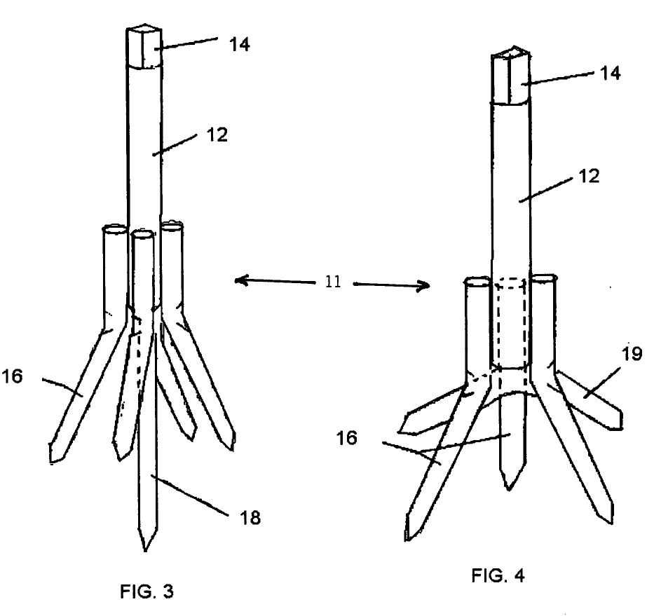

FIG. 2 is a perspective view of the embodiment shown in FIG. 1 with a vertical stabilizer 18, which acts as a center drill to prevent the attachment from drifting while in use.

FIG. 3 is a perspective view of a four blade 16 cultivating blade attachment 10 with a vertical stabilizer 18. This embodiment provides superior cultivation when used in a vertical direction.

FIG. 4 is a perspective view of a three blade 16 cultivating blade attachment 10 with a horizontal stabilizer 19. The horizontal stabilizer 19 allows the attachment 10 to be used on an angle and prevents drifting.

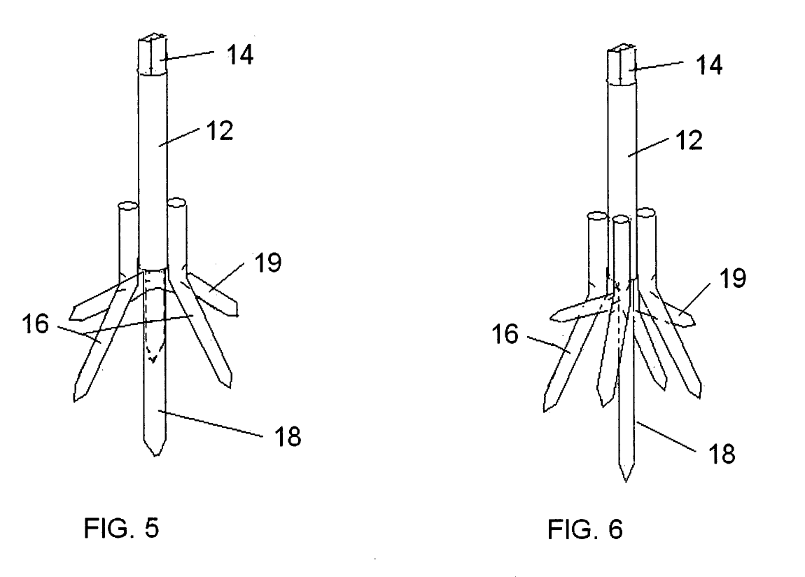

FIG. 5 is a perspective view of a three blade 16 cultivating blade attachment 10 with both vertical 18 and horizontal 19 stabilizers. The horizontal 19 stabilizer is particularly of use where the blades 16 are held on a slant to disc the soil.

FIG. 6 is a four blade 16 cultivating blade attachment 10 with both vertical 18 and horizontal 19 stabilizers.

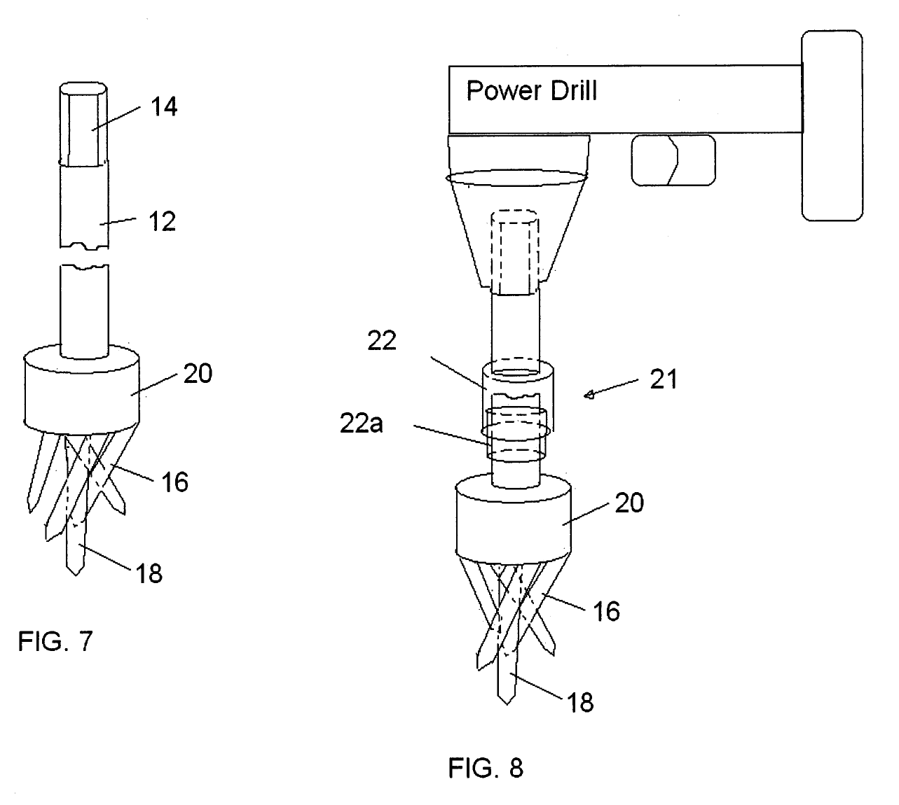

FIG. 7 is a perspective view of a four blade 16 cultivating blade attachment 10 with bent blades 16 and a vertical stabilizer 18. This embodiment has a base 20 to which the bent blades 16 are attached around the vertical stabilizer.

FIG. 8 is a perspective view of the embodiment of claim 7 with a telescoping shaft assembly 21 comprising telescoping sections 22, 22a. This telescoping shaft assembly 21 is removably attached to a power drill via a chuck as shown. Although a power drill is illustrated, it is contemplated that any variable speed low to high torque power motor source may be employed, such as pneumatic, electric, and combustion engines.

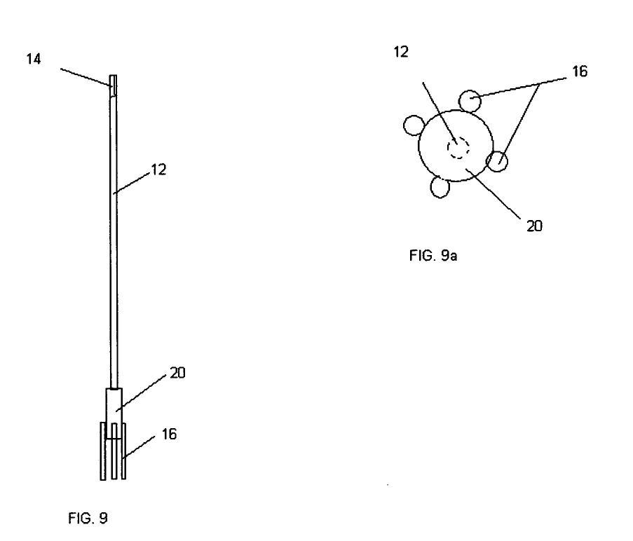

FIG. 9 is a front view of a four blade cultivating blade attachment with parallel aligned blades 16 structured such that they cut soil cores, which are particularly suited for removing weeds with central tap roots, such as dandelions.

FIG. 9a is an end view of the four blade cultivating blade attachment shown in FIG. 9 showing the four equally spaced apart blades 16 attached to the base 20.

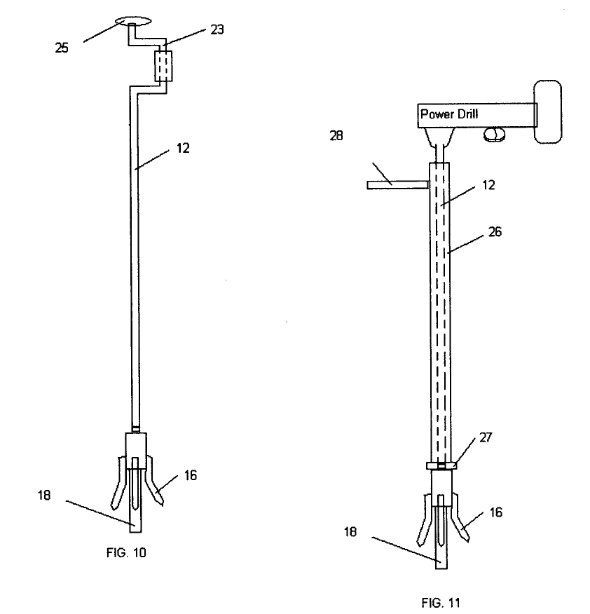

FIG. 10 is a perspective view of a manually operated cultivator with a crank handle 23 attached to the shaft 12 and a pommel 26 such that a user can rotate shaft. The cultivator attachment 10 may be removably attached to the shaft 12 so that its blades 16 are manually rotated to till the soil. Included is the stabilizer blade 18 to prevent blade migration as described above.

FIG. 11 is a perspective view of a preferred power operated cultivator driven by a power drill, which attaches to the attachment end 14 of a cultivator attachment 10, or can be integrated as a single cultivating tool with its own power source. The shaft 12 is surrounded by a tubular casing 26, which allows the shaft to spin therein. A washer 27 may be included at the end of the tubular casing 26 as shown to insure that the tubular casing 26 does not interfere with the base 20. A handle 28 is affixed at right angles to the tubular casing 26 to assist a user in aligning and operating the cultivator.

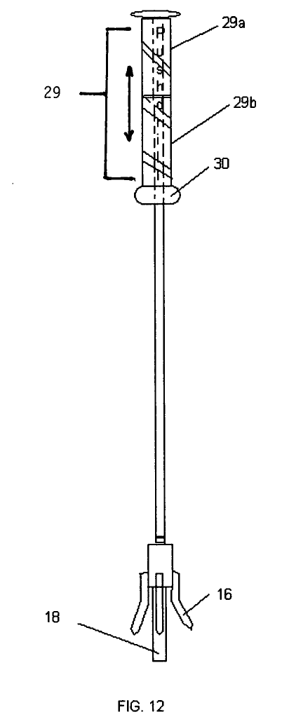

FIG. 12 is a perspective view of another manually operated cultivator employing a push drill 29 mechanism associated with the attachment end 14. This push drill mechanism 29 also includes a variable torque gearing system 30 to adjust and vary the torque. The push drill 29 comprises two separating handles 29a, 29b, which are alternatively separated and pushed together to cause the slant channel push drill rotating mechanism to rotate the shaft 12. Other push drill 29 mechanisms employ a standard push drill mechanism such as that employed in the Yankee™ push drill made by Stanley® of New Britain, Conn.

The cultivator blade attachment 10 can be removably attached to any power drill, and may be modified to apply to other power equipment at higher levels of torque, particularly when adapted with the vertical stabilizer, which allows its usage at medium to high speed settings. If operated at higher speeds, soil is thrown and dispersed. At lower speeds the cultivator blade attachment disturbs soil very little and allows uprooting of weeds without tearing, making complete removal possible, or burying them for composting.

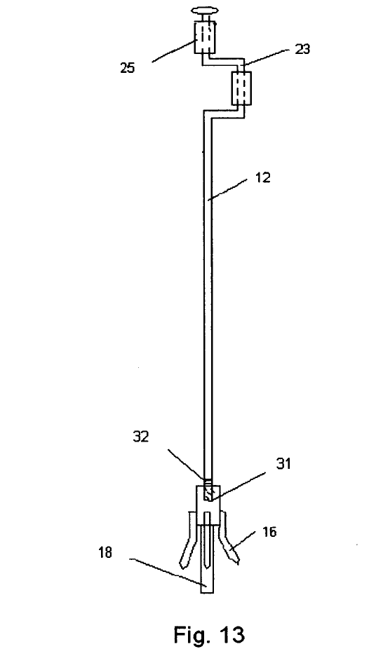

FIG. 13 is a perspective view of another manually operated cultivator 10 with dual handles 25. The end 32 of the shaft 12 is threaded. A nut 31 with corresponding threads is attached to the blades 16 and center stabilizer 18 forming a separate blade assembly, which can be removably screwed onto the end of the shaft to interchange different sized blades for different soil conditions. Although a threaded end 32 with corresponding nut 31 connecting structure is illustrated, other connector assemblies to removably attach different blades to the cultivator shaft 12 may be employed, such as quick release bit structure, removable pins, sockets, etc.

If required, the powered cultivator 10 may include an adjustable torque gearing system shown in FIG. 12 to allow the user to adjust the torque required in differing soils for cultivation. Usually, the variable speed drill is employed for this purpose. However, if a fixed speed power source is employed, the adjustable torque gearing system may then be included.

The above cultivating blade attachment and cultivator thus provides the combined advantages of either a manual or a powered hand cultivator, as well as the efficiencies of an interchangeable attachment blades readily adaptable for various soil conditions. It generally is made of hard metal for efficient use in all types of soils. It is ideal for soil mixing, aerating, weed destruction, with the capability to cultivate in and around plants, rocks, planting borders, side walks, under fences, decorations, and many remote places conventional tillers cannot reach.

Although this specification has referred to the illustrated embodiments, it is not intended to restrict the scope of the appended claims. The claims themselves recite those features deemed essential to the invention.

1. A cultivator blade attachment comprising:
a. a shaft with
i. an attachment end adapted to attach to a manual or powered rotary power source to rotate the shaft, and
ii. a cultivator end
b. at least three equally spaced apart spiked blades each having an attachment end and a tip end, the attachment ends attached circumferentially in radially spaced apart downward alignment to the cultivator end at an angle to spread the separated tips at an acute angle relative to the shaft and adapted to drill into the soil as the cultivating blade attachment is rotated and entangle weeds there around, the span of the separated tips selected based on the soil compaction, and
c. a central stabilizer attached to the cultivator end in alignment with the shaft and of a length extending beyond the separated blade tips and structured to drill into the soil and prevent blade migration, during usage.

2. A cultivator blade attachment according to claim 1, wherein the attachment end is adapted to fit within a drill chuck of a power drill.

3. A cultivator blade attachment according to claim 1, wherein the attachment end is adapted to attach to a crank shaft with handles to rotate the shaft and turn the blades.

4. A cultivator blade attachment according to claim 1, wherein the attachment end is adapted to removably attach to a power motor.

5. A cultivator blade attachment according to claim 1, wherein the stabilizer comprises a central drill point attached to the center of the cultivator end with a drill tip extending beyond the tips of the blades to drill into soil.

6. A cultivator blade attachment according to claim 1, wherein the stabilizer comprises a horizontal pair of blades with tips affixed to the center of the attachment end such that the horizontal blade tips are interposed between the spaced apart blades and are spread apart wider and not in planer alignment with the spaced apart blade tips to act as a horizontal stabilizer to minimize blade migration and disc soil when the blades are used in acute angular alignment with the soil.

7. A cultivator blade attachment according to claim 1, wherein the length of the shaft is adjustable.

8. A cultivator blade attachment according to claim 1, wherein the shaft is of a length to allow use of the cultivator blade attachment without a user having to stoop.

9. A cultivator blade attachment according to claim 1, wherein the attachment end is adapted to removably attach to a power source.

10. A cultivator blade attachment comprising:
i. a shaft with an attachment end adapted to attach to a chuck of a variable speed low to high torque rotary drill having a handle to assist in aligning the cultivating blade attachment, and a cultivator end, and,
ii. at least four equally spaced apart spiked blades with attachment ends and tips, each attachment end attached to the cultivator end to hold the blades in parallel alignment with the shaft with each blade bent such that their tips are spaced apart and structured to drill a core into the soil as the blades are rotated, the span of the separated tips selected based on the soil compaction,

11. A cultivator blade attachment according to claim 10, wherein the four equally spaced apart spiked blades are attached at an angle to the shaft, and including a vertical central drill point attached to the center of the cultivator end to extend beyond the tips of the blades and adapted to drill into the soil such that the soil is tilled without blade migration, and a second horizontal blade interposed between the four equally spaced apart blades with the tips of the horizontal blade spread apart wider and not in planer alignment with the tips of the four equally spaced apart blades, which act as horizontal stabilizers to minimize blade migration when in use either vertically or on an angle.

12. A cultivator comprising:
a shaft with an attachment end adapted to attach to a rotary power source, and a cultivator end,
at least three equally spaced apart bent spiked blades with attachment ends and tips, each attachment end attached to the cultivator end with each blade bent such that their separated tips are spaced apart and structured to dill into the soil as the cultivating blade attachment is rotated to entangle weeds, when turned the span of the separated tips selected based on the soil compaction,
at least one vertical or horizontal stabilizer attached to the cultivator end with structure to drill into the soil to minimize blade migration during use, and
a manual or powered variable speed low to high torque rotary power source attached to the attachment end adapted to be gripped, activated, and positioned by a user.

13. A cultivator according to claim 12, wherein the stabilizer is a central drill point attached to the center of the cultivator end to extend beyond the tips of the blades and adapted to drill into the soil.

14. A cultivator according to claim 12, wherein the rotary power source comprises a hand crank attached to the attachment end, with handles for gripping and operating by a user.

15. A cultivator according to claim 14, wherein and the stabilizer comprises a central drill point attached to the center of the cultivator to extend beyond the tips of the blades and adapted to drill into the soil.

16. A cultivator according to claim 12, wherein the rotary power source comprises a variable speed motor structured to be held and activated by a user with one hand, and including a tubular hand guide surrounding the shaft to enable the center shaft to spin freely within the tubular hand guide structured to be held by the other hand to assist in controlling the tool alignment when the user is using a longer shaft tool in a standing position.

17. A cultivator according to claim 16, including a handle affixed at right angles to the tubular hand guide to assist a user in aligning and operating the cultivator.

18. A cultivator according to claim 12, including an adjustable torque gearing system associated with the shaft and cultivator blades to allow the user to adjust the torque of the blades required for use in differing soils for cultivation.

19. A cultivator according to claim 12, including connecting structure affixed to the blades adapted to removably interchangeably secure the blades to the cultivator end.

20. A cultivator comprising:
a shaft with an attachment end and a cultivator end,
a manual or powered rotary power source attached to the attachment end and structured to be held and operated by a user, and
at least one blade assembly with a base structured to removably attach to the cultivator end having
i. at least three equally spaced apart outwardly bent spiked blades each attached to a base end with each blade bent such that their tips are spaced apart and planarly aligned normal to the shaft and structured to drill into the soil as the cultivating blade attachment is rotated to entangle weeds, when turned, and
ii. a vertical or horizontal stabilizer structured attached to the center of the base end adapted to drill into the soil to minimize blade migration when rotated during use.
